(19) United States
(12) Patent Application Publication
(10) Pub. No.: US 2004/0266483 A1
(43) Pub. Date: Dec. 30, 2004

(54) Calibration apparatus for smart antenna and method thereof

(76) Inventor: Seung-Won Choi, Seoul (KR)

Correspondence Address: JACOBSON HOLMAN PLLC, 400 SEVENTH STREET N.W., SUITE 600, WASHINGTON, DC, 20004, US

(21) Appl. No.: 10/491,724

(22) PCT Filed: Nov. 14, 2001
(86) PCT No.: PCT/KR01/01939

(30) Foreign Application Priority Data
Oct. 5, 2001 (KR) 2001/61515

(51) Int. Cl. H04M 1/00

(52) U.S. Cl. 455/562.1; 455/69

(57) ABSTRACT

A calibration apparatus for smart antenna and a method thereof are disclosed. The calibration apparatus in a receiving mode of an array antenna system includes: an additional antenna for receiving a calibration signal, which is used for calibration, from one of transmitting antennas; a frequency converter for converting a frequency of the calibration signal received from the additional antenna and generating a frequency-converted signal; a plurality of receiving frequency-converted signal from the frequency converter and outputting the frequency-converted signal; a plurality of receiving modules for converting the frequency-converted signal from the receiving antenna to have characteristics for the array antenna system; a transmitting module for generating the calibration signal and providing the calibration signal to the transmitting antenna; a calibration unit for controlling each of the receiving antennas, the receiving modules, the transmitting antenna and the transmitting modules to have the same phase characteristics based on signals received from the receiving modules; and a plurality of switches for switching a connection between the frequency converter and the receiving antennas.

### TECHNICAL FIELD

The present invention relates to a calibration apparatus and method for an array antenna and a computer readable record medium for executing the method and, more particularly, to the calibration apparatus and method of the array antenna for revising a phase characteristics of a receiver and transmitter coupled to each antenna element in the wireless communication environment.

### BACKGROUND ARTS

In generally, a smart antenna system controls a direction of the antenna automatically toward an optimized direction in response to information analyzed from received input signals of each element of an antenna array. Such the smart antenna is called as an adaptive array antenna.

An object of the smart antenna system is to provide an ideal beam, which gives the maximum gain to a direction of a mobile station and the minimum gain to an undesired direction by using a parameter value calculated from received signals in every snapshot. The ideal beam of the smart antenna system has to be provided not only in receiving mode but also in transmitting mode.

However, in the receiving mode, the ideal beam of the smart antenna system is hard to be provided due to various technical difficulties. Although the difficulties has been overcame for providing the ideal beam in the receiving mode, phase characteristics of paths need to be revised identically for acquiring the ideal beam in transmitting mode. Herein the paths are coupled to elements of the antenna in the smart antenna system.

The calibration technique acquires the identical beam characteristic in the transmitting mode by using the parameter value calculated in the receiving mode. That is, for gaining identical beam characteristics of the smart antenna in the transmitting mode within the receiving mode, all phase characteristics of paths related each element of the smart antenna system need to be revised identically.

Therefore, the calibration technique is implemented to a transmitter and a receiver and corrects the phase characteristic of each path of the transmitter and the receiver. For implementing the calibration technique in real communication system, it has to be designed for automatic performing a calibration process before/after installing the communication system.

A calculation method of the parameter value providing the ideal beam characteristic in a receiving mode has been proposed in various patent and thesis. The representative of the calculation method of the parameter value is disclosed in KOREA Patent Application No. 10-1999-0241502.

Additionally, conventional techniques related to the calibration are described in an article 1 by K. Nishimori, et al., “Automatic calibration method of adaptive array considering antenna characteristics for FDD system”, Proceedings of ISAP2000, Fukuoka, Japan, Aug. 21-25, 2000 and article 2 by K. Nishimori, et al, “A new calibration method of adaptive array for TDD systems”, IEEE Ap-S digest, pp 1444-1447, July 1999.

The article 1 and 2 introduces a calibration method effectively revising phase characteristics of the transmitter and the receiver and the method introduced in the article 1 and 2 are possible to practice in a base station of the mobile communication system.

However, the method proposed in the article 1 and 2 has implement limitations. The smart antenna system has to be a specific configuration such as a circular array antenna for implementing the method. The additional element for calibration has to be located in a center of the circular array and it is complicated process to adjust a phase of the additional antenna element and phases of each antenna element of the array antenna identically.

Therefore, it is impossible to implement the conventional method for calibration in an array antenna composed of a linear patch antenna.

### SUMMARY OF THE INVENTION

It is, therefore, an object of the present invention to provide a calibration apparatus of an array antenna system for effective data communication by revising a phase characteristic of a receiver and transmitter coupled to each array antenna element by using a parameter value, which is calculated in a receiving mode, in a transmitting mode.

It is another object of the present invention to provide a calibration method of an array antenna system for effective data communication by revising a phase characteristic of a receiver and transmitter coupled to each array antenna element by using a parameter value, which is calculated in a receiving mode, in a transmitting mode.

It is still another object of the present invention to provide a computer readable record medium for executing the method.

In accordance with an aspect of the present invention, there is provided a calibration apparatus of an array antenna system in a receiving mode, including: an additional antenna for receiving a signal for calibration from one of transmitting antennas of an array antenna and applying the received signal to a plurality of receiving antennas of the array antenna system; a frequency converting unit for converting a frequency of the signal received from the additional antenna and generating a frequency-converted signal for providing to a plurality of receiving antennas; a plurality of receiving antennas for receiving the frequency-converted signal from the frequency converter and outputting the frequency-converted signal to a receiving module; a plurality of receiving modules for receiving the frequency-converted signal and converting the frequency-converted signal to have characteristics for the array antenna system; a transmitting antenna for transmitting a signal to the additional antenna; a transmitting module for converting a signal to transmit to the transmitting antenna; a calibration unit for controlling each of the receiving antennas and the receiving modules to have the same phase characteristics based on signals received from the receiving modules; and a plurality of switching unit for switching a connection between the frequency converting unit and the receiving antennas.

In accordance with another aspect of the present invention, there is also provided a calibration apparatus in a transmitting mode of an array antenna system, including: an additional antenna for receiving a signal for calibration from one of transmitting antennas of the array antenna system and transmitting the received signal; a frequency converting unit for converting a frequency of the signal received from the transmitting antenna for transmitting to the receiving antenna; a plurality of transmitting antennas for providing a signal to the frequency converting unit; a plurality of transmitting modules for converting a signal for providing to the transmitting antenna; the receiving antenna for receiving a signal from the additional antenna; a receiving module for receiving a signal through the receiving antenna and converting the signal to have characteristics for the system; a calibration unit for controlling each of the receiving antennas, the receiving modules, the transmitting antennas and transmitting modules to have the same phase characteristics based on signals received form the receiving modules; and a plurality of switching unit for switching a connection between the frequency converting unit and the receiving antennas.

In accordance with still another aspect of the present invention, there is also provided a calibration apparatus of an array antenna system in a receiving mode, including: a frequency converting unit for receiving a signal for calibration from one of transmitting antennas of the array antenna, converting the received signal and generating a frequency-converted signal for applying the frequency-converted signal to a plurality of receiving antenna of the array antenna system; a plurality of receiving antennas for receiving the frequency converted signal from the frequency converting unit and outputting the frequency-converted signal to a receiving module; a plurality of receiving modules for receiving the frequency-converted signal and converting the frequency-converted signal to have characteristics for the system; the transmitting antenna for applying a signal to the frequency converting unit; a transmitting module for converting a signal to transmit to the transmitting antenna; a calibration unit for controlling each phase characteristic of the receiving antennas, the receiving modules, the transmitting antennas and the transmitting modules to have the same phase characteristics based on signals received from the receiving modules; a plurality of first switching unit for switching a connection between the frequency converting unit and the receiving antennas; and a plurality of second switching unit for switching a connection between the frequency converting unit and the transmitting antennas.

In accordance with further still another aspect of the present invention, there is also provided a calibration apparatus of an array antenna system in a transmitting mode, including: a frequency converting unit for receiving a signal for calibration from the plurality of the transmitting antenna of the array antenna system, converting the received signal and generating a frequency-converted signal for applying the frequency-converted signal to one of receiving antenna of the array antenna system; the plurality of transmitting antennas for providing a signal to the frequency converting unit; a plurality of transmitting modules for converting the signal in order to provide the signal to the transmitting antenna;

the receiving antenna for receiving a signal from the additional antenna; a receiving module for receiving the signal from the receiving antenna and converting the signal to have characteristics for the system; a calibration unit for controlling each of the receiving antennas, the receiving modules, the transmitting antennas and the transmitting module to have the same phase characteristics by receiving the signal from the transmitting module; a plurality of first switching unit for switching a connection between the frequency converting unit and the transmitting antennas; and a plurality of second switching unit for switching a connection between the frequency converting unit and the receiving antennas.

In accordance with further still another aspect of the present invention, there is also provided a calibration method of array antenna system in a receiving mode for adjusting all phase characteristics of receivers identically, including steps of: a) transmitting a signal for calibration by using one of transmitting antennas in an array antenna system; b) receiving the signal at the additional antenna and applying the signal to a plurality of receiving antennas in the array antenna system; c) controlling each of the transmitting module, transmitting antenna and receiving module, receiving antenna to have same phase characteristic; and d) eliminating the additional antenna from the array antenna system.

In accordance with further still another aspect of the present invention, there is also provided a calibration method of a transmitting mode of array antenna system for adjust all phase characteristics of transmitter identically, including steps of: a) applying signals for calibration to additional antenna by using a plurality of transmitting antennas in the array antenna system; b) transmitting the applied signal from the additional antenna to one of receiving antennas in the array antenna system; c) controlling each of the transmitting module, transmitting antenna and receiving module, receiving antenna to have same characteristics; and d) eliminating the additional antenna from the array antenna system.

In accordance with further still another aspect of the present invention, there is also provided a computer readable record medium for executing a calibration method of a receiving mode of array antenna system for adjust all phase characteristics of receivers, including functions of: a) transmitting a signal for calibration by using one of transmitting antennas in an array antenna system; b) receiving the signal at the additional antenna and applying the signal to a plurality of receiving antennas in the array antenna system; c) controlling each of the transmitting module, transmitting antenna and receiving module, receiving antenna to have same phase characteristic; and d) eliminating the additional antenna from the array antenna system.

In accordance with further still another aspect of the present invention, there is also provided a computer readable record medium for executing a calibration method of a transmitting mode of array antenna system for adjust all phase characteristics of transmitter, including functions of: a) applying signals for calibration to additional antenna by using a plurality of transmitting antennas in the array antenna system; b) transmitting the applied signal from the additional antenna to one of receiving antennas in the array antenna system; c) controlling each of the transmitting module, transmitting antenna and receiving module, receiving antenna to have same characteristics; and d) eliminating the additional antenna from the array antenna system.

### BRIEF DESCRIPTION OF THE DRAWINGS

The above and other objects and features of the present invention will become apparent from the following description of the preferred embodiments given in conjunction with the accompanying drawings, in which:

FIG. 1 is a diagram for explaining necessity of calibration in a wireless communication system in accordance with a preferred embodiment of the present invention;

FIG. 2 is a graph for illustrating a phase difference of the array antenna system in accordance with a preferred embodiment of the present invention;

FIG. 3 is a diagram for illustrating a calibration apparatus of the array antenna system in receiving mode in accordance with a preferred embodiment of the present invention;

FIG. 4 is a diagram for illustrating a calibration apparatus of the array antenna in transmitting mode system in accordance with a preferred embodiment of the present invention;

FIG. 5 is a flowchart for illustrating a calibration method of the array antenna system in receiving mode in accordance with a preferred embodiment of the present invention;

FIG. 6 is a flowchart for illustrating a calibration method of the array antenna system in transmitting mode in accordance with a preferred embodiment of the present invention;

FIG. 7 is a diagram for illustrating a calibration apparatus of the array antenna system in receiving mode in accordance with another preferred embodiment of the present invention; and

FIG. 8 is a diagram for illustrating a calibration apparatus of the array antenna system in transmitting mode in accordance with another preferred embodiment of the present invention.

### MODES FOR CARRYING OUT THE INVENTION

Other objects and aspects of the invention will become apparent from the following description of the embodiments with reference to the accompanying drawings, which is set forth hereinafter.

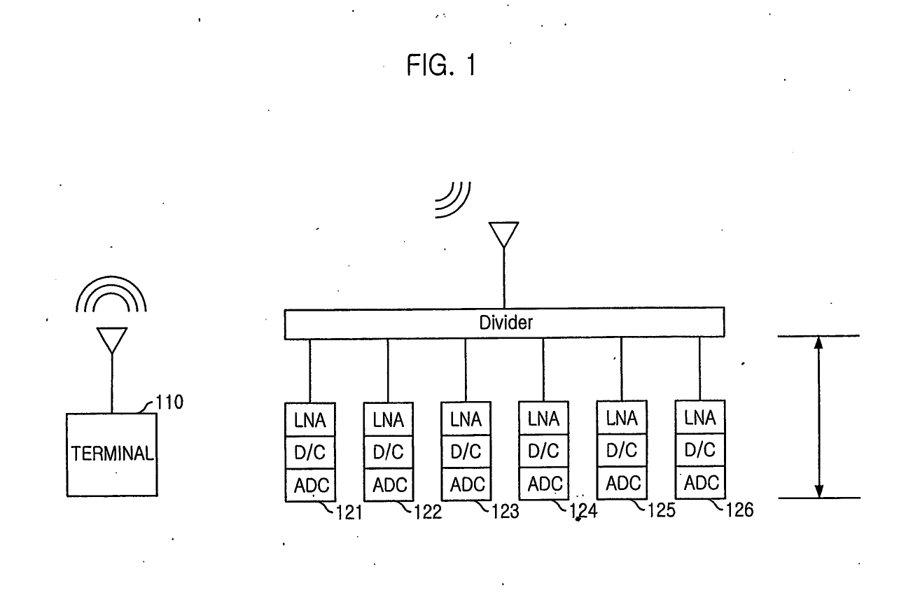

FIG. 1 is a diagram for explaining necessity of calibration in a wireless communication system in accordance with a preferred embodiment of the present invention.

As shown in FIG. 1, an array antenna system, in which the present invention is implemented, receives signals transmitted from a mobile station 110, divides the received signals to a receiving circuit of each antenna element of the array antenna by using a divider and measures phase error of each antenna element.

FIG. 1 shows an example of measuring the phase error of six antenna elements by using a value of an element of antenna 212 as a standard value for comparison the phase error.

Table.1 shows mean values of the phase error of five antenna elements 122 to 126 by using the first antenna element 121 as a standard and Table.2 represents a standard deviation of phase error of five antenna elements 122 to 126 by using the first antenna element 121 as a stand.

Table.3 represents values subtracted from the maximum phase error of the five antenna elements 122 to 126 to the mean value of phase error of each antenna element and Table.4 shows values subtracted from the mean value of phase error of each antenna element to the minimum phase error of the five antenna elements 122 to 126.

TABLE 1

| mean (Φ1) | mean (Φ2) | mean (Φ3) | mean (Φ4) | Mean (Φ5) | mean (Φ6) |
|---|---|---|---|---|---|
| 0 | 1.7710 | 3.3234 | 0.4026 | 0.9678 | 4.5984 |

TABLE 2

| std (Φ1) | std (Φ2) | std (Φ3) | std (Φ4) | std (Φ5) | std (Φ6) |
|---|---|---|---|---|---|
| 0 | 0.0716 | 0.1157 | 0.1021 | 0.1473 | 0.0958 |

TABLE 3

| Max (Φ1) − | Max (Φ2) − | Max (Φ3) − | Max (Φ4) − | Max (Φ5) − | Max (Φ6) − |
|---|---|---|---|---|---|
| mean (Φ1) | mean (Φ2) | mean (Φ3) | mean (Φ4) | mean (Φ5) | mean (Φ6) |
| 0 | 0.1556 | 0.2911 | 0.2752 | 0.4101 | 0.3006 |

TABLE 4

| Mean (Φ1) − | Mean (Φ2) − | Mean (Φ3) − | Mean (Φ4) − | Mean (Φ5) − | Mean (Φ6) − |
|---|---|---|---|---|---|
| min (Φ1) | min (Φ2) | min (Φ3) | min (Φ4) | min (Φ5) | min (Φ6) |
| 0 | 0.1939 | 0.3678 | 0.3092 | 0.4213 | 0.2670 |

Referring to Tables 1 to 4, each phase of the antenna channel has all different values, that is, the calibration is required for the wireless communication system.

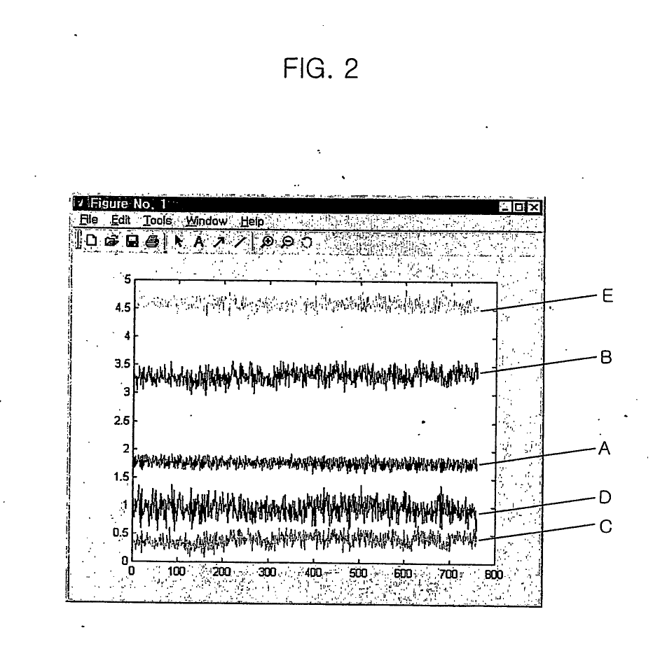

FIG. 2 is a graph for illustrating a phase difference of the array antenna system in accordance with the present invention. It shows phase errors of the five antenna elements by using the phase error of antenna element 121 as the standard. “A” represents a phase error of the antenna element 122 and “B”, “C”, “D”, and “E” represents each phase error of the antenna elements 123 to 126.

As show in FIG. 2, the phase characteristics of each antenna channel are not identical but those are saturated at a mean value. Therefore, if it is possible to measure the phase value of antenna channel, then it also can be calibrated by using the phase value.

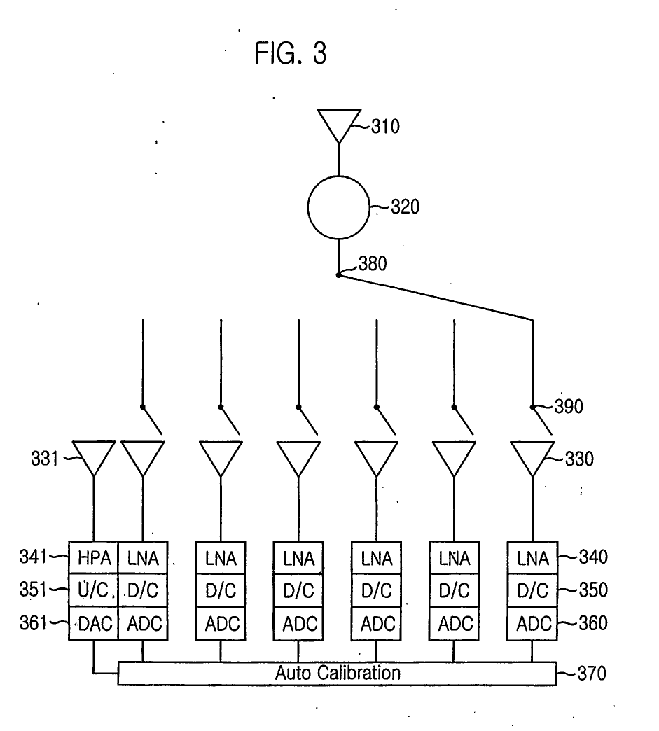

FIG. 3 is a diagram for illustrating a calibration apparatus of the array antenna system in a receiving mode in accordance with the preferred embodiment of the present invention.

As shown in FIG. 3, the calibration apparatus of the present invention includes an additional antenna 310, a frequency converter 320, a plurality of receiving antennas 330 installed in every pre-determined gap, a transmitting antenna 331, a LNA 340, a high power amplifier 341, a down converters (D/C) 350, an up converter (U/C) 351, an analog digital converter (ADC) 351, a digital analog converter (DAC) 361, a calibrator 370, a switch 380 and a plurality of switches 390.

Generally, the antennas in the antenna system are not distinguished by a transmitting antenna and a receiving antenna so the transmitting antenna 331 is randomly selected from equipped plurality of antennas in a smart antenna system and it is not equipped additionally for embodying the present invention.

Operation steps of the calibration apparatus of the present invention are explained in detail as flows.

The transmitting antenna 331 transmits a signal for calibration and the additional antenna 310 receives the signal. The frequency converter 320 converts the received signal, which is Tx frequency, to Rx frequency.

The converted frequency signal is applied to the plurality of receiving antenna 330 through turned-on the plurality of switch 390 and the switch 380. The LNA 340 reduces a noise of the received signal and the D/C 350 down converts a frequency to be suitable for the antenna system. The ADC 360 converts an analog signal to a digital signal.

The phase characteristics of the frequency converter 320 and the receiving antenna 330 have to be identical and it can be implemented simply as micros strip antenna. Even in the case that the phase characteristics of the frequency converter 320 and the receiving antenna 330 are not identical, the present invention can be implemented by calibrating a difference between each paths.

The calibrator 370 records and stores a phase value received from the ADC 360 in a memory and then revises a phase difference of each receiver in receiving mode.

After revising the phase difference, the switch 390 becomes turned off so the receiving antenna 330 and the frequency converter 320 become disconnected. The receiving antenna 330 is operated as a generic receiving antenna assigned to a sector or cell.

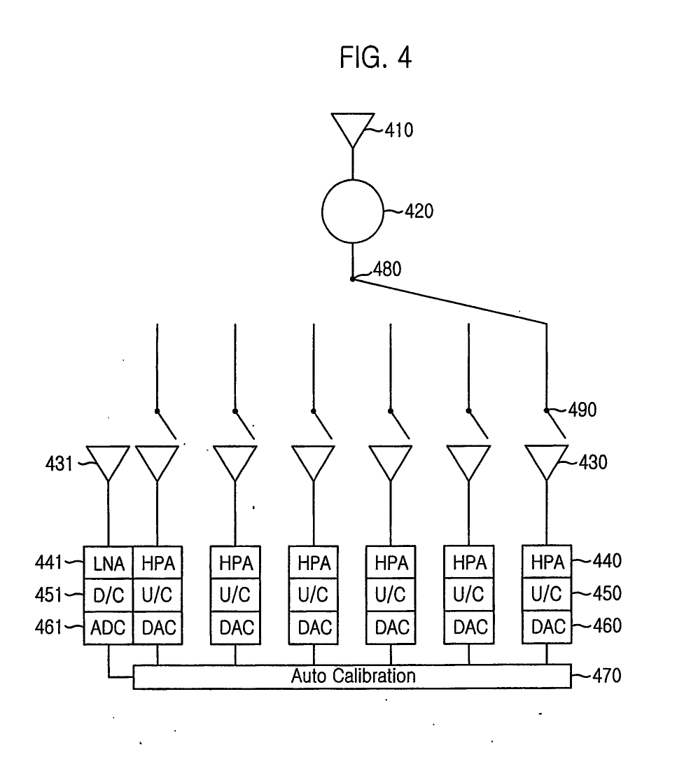

FIG. 4 is a diagram for illustrating a calibration apparatus of the array antenna system in transmitting mode in accordance with the preferred embodiment of the present invention.

As show in FIG. 4, a calibration apparatus of the present invention includes an additional antenna 410, a frequency converter 420, a plurality of transmitting antennas 430, a receiving antenna 431, a plurality of HPA 440, a plurality of LNA 441, a plurality of down converters (D/C) 450, an up converter (U/C) 451, an analog digital converter (ADC) 461, a digital analog converter (DAC) 460, a calibrator 470, a switch 480 and a plurality of switches 490.

The receiving antenna 431 is randomly selected from an equipped plurality of antennas in a smart antenna system and it is not equipped additionally for embodying the present invention.

Operation steps of the calibration apparatus of the array antenna system in accordance with the present invention are explained in detailed as flows.

The plurality of transmitting antenna 430 applies a signal for calibration to the additional antenna 410 through switch 480 in case the switch 490 is turned on. The additional antenna 410 transmits the applied signal to the receiving antenna 431 and the receiving antenna 431 receives the transmitted signal from the additional antenna. The received signal is transformed to be suitable for the system by passing through the LNA 441, the D/C 451 and the ADC 461.

In here, a transmitting frequency of the plurality of transmitting antenna 430 is converted to receiving frequency by the frequency converter 420. The phase characteristic of path between the frequency converter 420 and the transmitting antenna 430 has to be same and it can be simply implemented as a micro strip antenna.

In here, the phase value of the ADC 461 of a receiving module of the receiving antenna 431 is gained.

The calibrator 470 controls the phase characteristics of the receiving mode and the transmitting mode by using the phase value.

After controlling the phase characteristics, the switch 490 becomes turned off and the transmitting antenna 430 and the frequency converter 420 becomes disconnected. The transmitting antenna 430 is operated as a transmitting antenna assigned in a sector or a cell.

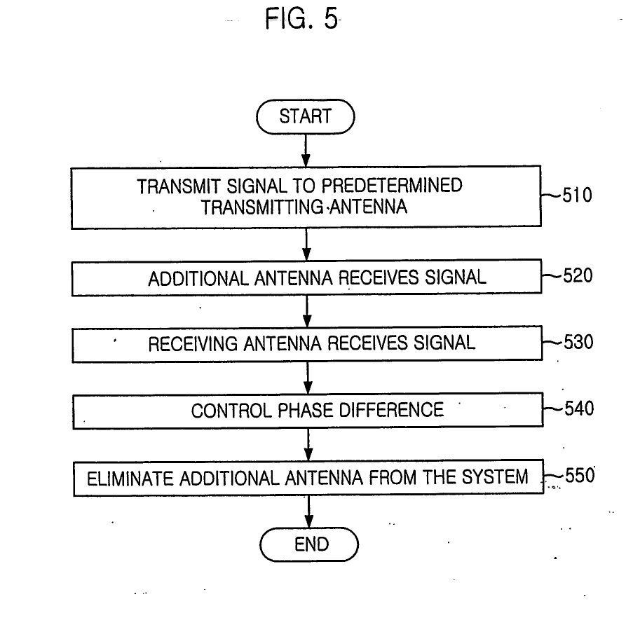

FIG. 5 is a flowchart for illustrating a calibration method in receiving mode of the array antenna system in accordance with the preferred embodiment of the present invention.

Referring to FIG. 5, at first, the transmitting antenna is selected from antennas in the antenna system and the selected transmitting antenna transmits a signal at step 510.

After an additional antenna receives the signal at step 520, the additional antenna applies the received signal to a plurality of array receiving antenna of the antenna system at step 530.

The receiving antenna applies the received signal to the antenna system, converts to be suitable for the system and controls the phase difference for calibration of phase characteristic of the receiver at step 540.

After controlling the phase characteristic, the additional antenna becomes disconnected by turning the switch off at step 550 and the receiving antenna is operated as a generic receiving antenna assigned in a sector and a cell.

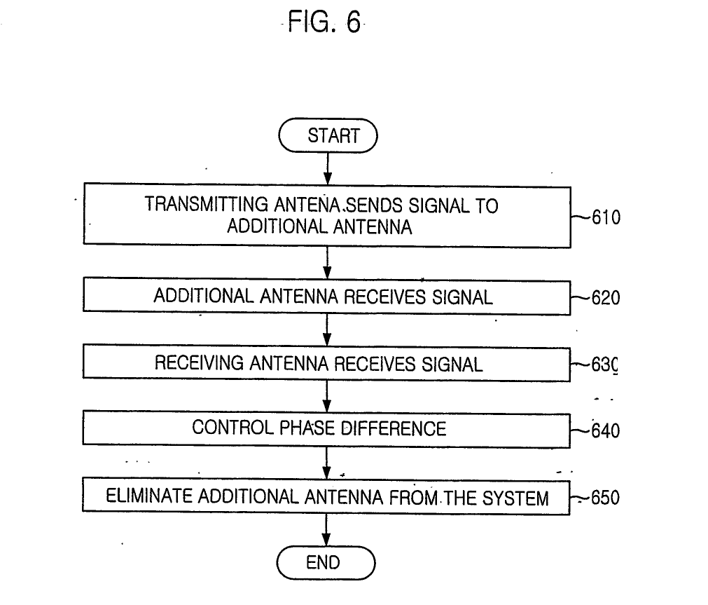

FIG. 6 is a flowchart for illustrating a calibration method in transmitting mode of the array antenna system in accordance with the preferred embodiment of the present invention.

Referring to FIG. 6, the calibration method of the present invention is started by a plurality of the transmitting antenna transmits a signal to the additional antenna for calibration at step 610 and the signal is transmitted to pre-selected receiving antenna on the antenna system at step 620.

The receiving antenna receives the signal at step 630 and converts the received signal to be suitable for the system. After converting the received signal, the receiving antenna controls a phase difference for phase calibration of the transmitter and the receiver at step 640.

After controlling the phase difference, the additional antenna is disconnected at step 630 and the transmitting antenna is operated as generic transmitting antenna assigned to a sector or a cell.

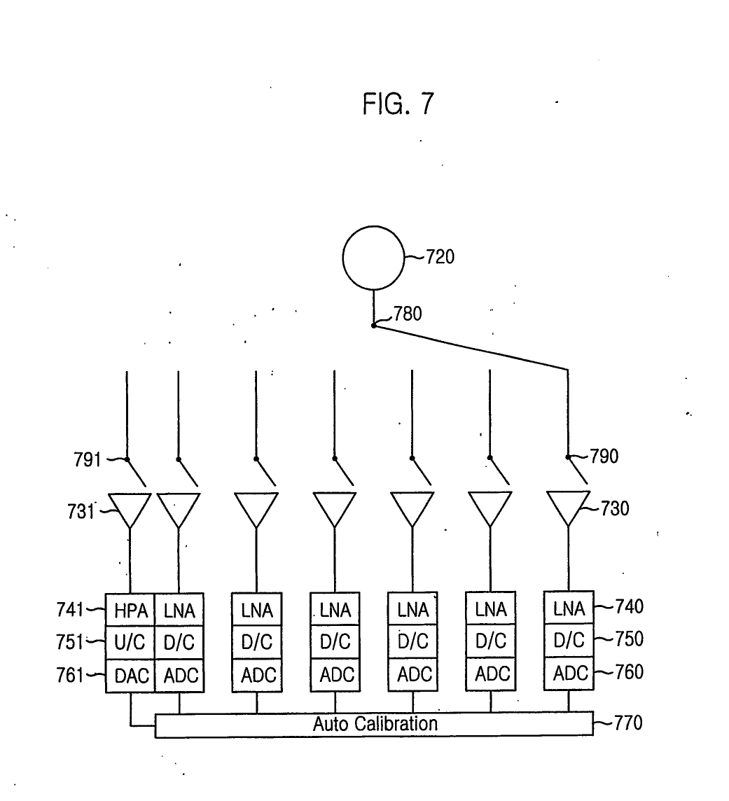

FIG. 7 is a diagram for illustrating a calibration apparatus in receiving mode of the array antenna system in accordance with another preferred embodiment of the present invention.

As shown in FIG. 7, the calibration apparatus of the present invention includes a frequency converter 720, a plurality of receiving antenna 730, a transmitting antenna 731, a LNA 740, HPA 741, D/C 750, U/C 751, ADC 760, DAC 761, calibrator 770, switch 780, a plurality of switch 791 and switch 791.

In the calibration mode, the transmitting antenna 731 and the frequency converter 720 is coupled by the switch 791 and the transmitting antenna 731 applies a signal to the frequency converter for calibration.

The frequency converter 720 converts received signal from the transmitting antenna 731 from transmitting frequency-to receiving frequency.

After converting, lest of operations of the calibration apparatus is same as shown in FIG. 3.

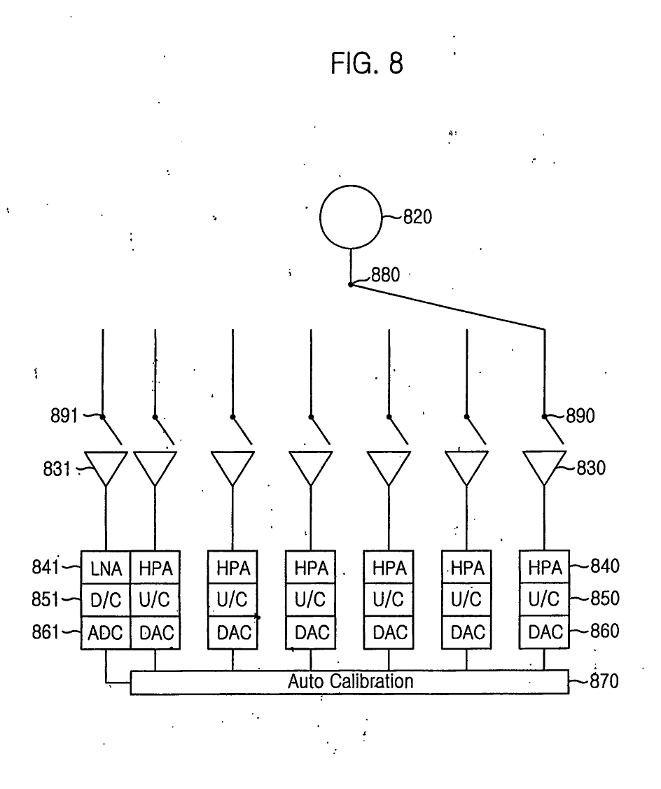

FIG. 8 is a diagram for illustrating a calibration apparatus in transmitting mode of the array antenna system in accordance with another preferred embodiment of the present invention.

Referring to FIG. 8, the calibration apparatus of the present invention includes a frequency converter 820, a plurality of transmitting antennas 830, a receiving antenna 831, a HPA 840, a LNA 841, a U/C 850, a D/C 851, a DAC 860, an ADC 861, a calibrator 870, a switch 880, a plurality of switches 890 and a switch 891.

In the calibration mode, the receiving antenna 831 and the frequency converter 820 is connected by the switch 891 and the frequency converter 820 applies the received signal from the receiving antenna 831 to the transmitting antenna 830.

After applying the signal, lest of operations of the calibration apparatus are same as shown in FIG. 4.

The above-mentioned calibration method of the present invention can be implemented as a program and stored in a computer readable record medium such as a CD-ROM, RAM, ROM, floppy disk, hard disk and optical magnetic disk.

The present invention can provide an ideal beam giving the maximum gain to a direction of a wanted user and the minimum gain to a direction of an un-wanted user by using a parameter value calculated from received signal in every snap shot in an array antenna used in the wireless communication system.

The present invention also can provide effective data communication by implementing the calibration of the phase characteristic of the receiver and the transmitter coupled to each antenna element as a simple hardware for using the parameter value, which is calculated in the receiving mode, in transmitting mode.

While the present invention has been described with respect to certain preferred embodiments, it will be apparent to those skilled in the art that various changes and modifications may be made without departing from the scope of the invention as defined in the following claims.

What is claimed is:

1. A calibration apparatus of an array antenna system in a receiving mode, comprising:
an additional antenna for receiving a signal for calibration from one of transmitting antennas of an array antenna and applying the received signal to a plurality of receiving antennas of the array antenna system;
a frequency converting means for converting a frequency of the signal received from the additional antenna and generating a frequency-converted signal for providing to a plurality of receiving antennas;
a plurality of receiving antennas for receiving the frequency-converted signal from the frequency converter and outputting the frequency-converted signal to a receiving module;
a plurality of receiving modules for receiving the frequency-converted signal and converting the frequency-converted signal to have characteristics for the array antenna system;
a transmitting antenna for transmitting a signal to the additional antenna;
a transmitting module for converting a signal to transmit to the transmitting antenna;
a calibration means for controlling each of the receiving antennas and the receiving modules to have the same phase characteristics based on signals received from the receiving modules; and
a plurality of switching means for switching a connection between the frequency converting means and the receiving antennas.

2. The apparatus as recited in claim 1, wherein the frequency converting means and the plurality of receiving antennas are arranged in a micro-strip line for controlling a phase of each path to have an identical phase.

3. A calibration apparatus in a transmitting mode of an array antenna system, comprising:
an additional antenna for receiving a signal for calibration from one of transmitting antennas of the array antenna system and transmitting the received signal;
a frequency converting means for converting a frequency of the signal received from the transmitting antenna for transmitting to the receiving antenna;
a plurality of transmitting antennas for providing a signal to the frequency converting means;
a plurality of transmitting modules for converting a signal for providing to the transmitting antenna;
said receiving antenna for receiving a signal from the additional antenna;
a receiving module for receiving a signal through the receiving antenna and converting the signal to have characteristics for the system;
a calibration means for controlling each of the receiving antennas, the receiving modules, the transmitting antennas and transmitting modules to have the same phase characteristics based on signals received form the receiving modules; and
a plurality of switching means for switching a connection between the frequency converting means and the receiving antennas.

4. The apparatus as recited in claim 3, wherein the frequency converting means and the plurality of transmitting antennas are arranged in a micro-strip line for controlling a phase of each path to have an identical phase.

5. A calibration apparatus of an array antenna system in a receiving mode, comprising:
a frequency converting means for receiving a signal for calibration from one of transmitting antennas of the array antenna, converting the received signal and generating a frequency-converted signal for applying the frequency-converted signal to a plurality of receiving antenna of the array antenna system;
a plurality of receiving antennas for receiving the frequency converted signal from the frequency converting means and outputting the frequency-converted signal to a receiving module;
a plurality of receiving modules for receiving the frequency-converted signal and converting the frequency-converted signal to have characteristics for the system;
said transmitting antenna for applying a signal to the frequency converting means;
a transmitting module for converting a signal to transmit to the transmitting antenna;
a calibration means for controlling each phase characteristic of the receiving antennas, the receiving modules, the transmitting antennas and the transmitting modules to have the same phase characteristics based on signals received from the receiving modules;
a plurality of first switching means for switching a connection between the frequency converting means and the receiving antennas; and
a plurality of second switching means for switching a connection between the frequency converting means and the transmitting antennas.

6. The apparatus as recited in claim 5, wherein the frequency converting means and the plurality of receiving antennas are arranged in a micro-strip line for controlling a phase of each path to have an identical phase.

7. A calibration apparatus of an array antenna system in a transmitting mode, comprising:
a frequency converting means for receiving a signal for calibration from the plurality of the transmitting antenna of the array antenna system, converting the received signal and generating a frequency-converted signal for applying the frequency-converted signal to one of receiving antenna of the array antenna system;
the plurality of transmitting antennas for providing a signal to the frequency converting means;
a plurality of transmitting modules for converting the signal in order to provide the signal to the transmitting antenna;
the receiving antenna for receiving a signal from the additional antenna;
a receiving module for receiving the signal from the receiving antenna and converting the signal to have characteristics for the system;
a calibration means for controlling each of the receiving antennas, the receiving modules, the transmitting antennas and the transmitting module to have the same phase characteristics by receiving the signal from the transmitting module;
a plurality of first switching means for switching a connection between the frequency converting means and the transmitting antennas; and
a plurality of second switching means for switching a connection between the frequency converting means and the receiving antennas.

8. The apparatus as recited in claim 7, wherein the frequency converting means and the plurality of transmitting antennas are arranged in a micro-strip line for controlling a phase of each path to have an identical phase.

9. A calibration method of array antenna system in a receiving mode for adjusting all phase characteristics of receivers identically, comprising steps of:
a) transmitting a signal for calibration by using one of transmitting antennas in an array antenna system;
b) receiving the signal at the additional antenna and applying the signal to a plurality of receiving antennas in the array antenna system;
c) controlling each of the transmitting module, transmitting antenna and receiving module, receiving antenna to have same phase characteristic; and
d) eliminating the additional antenna from the array antenna system.

10. The method as recited in claim 9, wherein step b) includes the steps of:
e) receiving the signal by the additional antenna;
f) applying the signal to the plurality of receiving antennas by using the additional antenna; and
g) converting the applied signal have characteristics for the system.

11. A calibration method of a transmitting mode of array antenna system for adjusting all phase characteristics of transmitter identically, comprising steps of:
a) applying signals for calibration to additional antenna by using a plurality of transmitting antennas in the array antenna system;
b) transmitting the applied signal from the additional antenna to one of receiving antennas in the array antenna system;
c) controlling each of the transmitting module, transmitting antenna and receiving module, receiving antenna to have same characteristics; and
d) eliminating the additional antenna from the array antenna system.

12. The method as recited in claim 11, wherein step b) includes the steps of:
e) converting the signal to have characteristics for the system;
f) applying the signal from the plurality of the transmitting antenna to the additional antenna; and
g) transmitting the signal by using the additional antenna.

13. A computer readable record medium for executing a calibration method of a receiving mode of array antenna system in order to adjust all phase characteristics of receivers, comprising functions of:
a) transmitting a signal for calibration by using one of transmitting antennas in an array antenna system;
b) receiving the signal at the additional antenna and applying the signal to a plurality of receiving antennas in the array antenna system;
c) controlling each of the transmitting module, transmitting antenna and receiving module, receiving antenna to have same phase characteristic; and
d) eliminating the additional antenna from the array antenna system.

14. A computer readable record medium for executing a calibration method of a transmitting mode of array antenna system in order to adjust all phase characteristics of transmitter, comprising functions of:
a) applying signals for calibration to additional antenna by using a plurality of transmitting antennas in the array antenna system;
b) transmitting the applied signal from the additional antenna to one of receiving antennas in the array antenna system;
c) controlling each of the transmitting module, transmitting antenna and receiving module, receiving antenna to have same characteristics; and
d) eliminating the additional antenna from the array antenna system.
